(19) United States
(12) Patent Application Publication
(10) Pub. No.: US 2017/0025881 A1
(43) Pub. Date: Jan. 26, 2017

(54) WIRELESS CHARGER SYSTEM AND METHOD

(71) Applicant: HON HAI PRECISION INDUSTRY CO., LTD., New Taipei (TW)

(72) Inventors: Yu-Ching CHIEN, New Taipei (TW); Chuang-Wei TSENG, New Taipei (TW); Che-Hsun CHEN, New Taipei (TW)

(21) Appl. No.: 14/804,815

(22) Filed: Jul. 21, 2015

(51) Int. Cl. H02J 7/02

(52) U.S. Cl. CPC H02J 7/025

(57) ABSTRACT

A wireless charger system includes a charging module and at least one receiving module. The receiving module is configured to receive a power from the charging module wirelessly for charging a device. The charging module includes a source module, a control module, and a charging antenna. The receiving module includes a receiving antenna and a converting module. The control module is also configured to detect a perturbation of a current of the charging module. When the perturbation is detected, the control module is configured to increase a voltage outputted from the source module; when the perturbation is not detected, the control module is configured to decrease the voltage outputted from the source module. The disclosure further provides a wireless charger method.

### FIELD

The subject matter herein generally relates to wireless charger systems and a wireless charger method using the wireless charger system.

### BACKGROUND

For a magnetic resonance type or a magnetic inductive type of wireless charging technology, it is desirable that voltages received by charged devices are in optimal charging efficiencies.

### BRIEF DESCRIPTION OF THE DRAWINGS

Implementations of the present technology will now be described, by way of example only, with reference to the attached figures.

FIG. 1 is a block diagram of an embodiment of a wireless charger system.

FIG. 2 is a flowchart of an embodiment of the wireless charger method using the wireless charger system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a wireless charger system 1000.

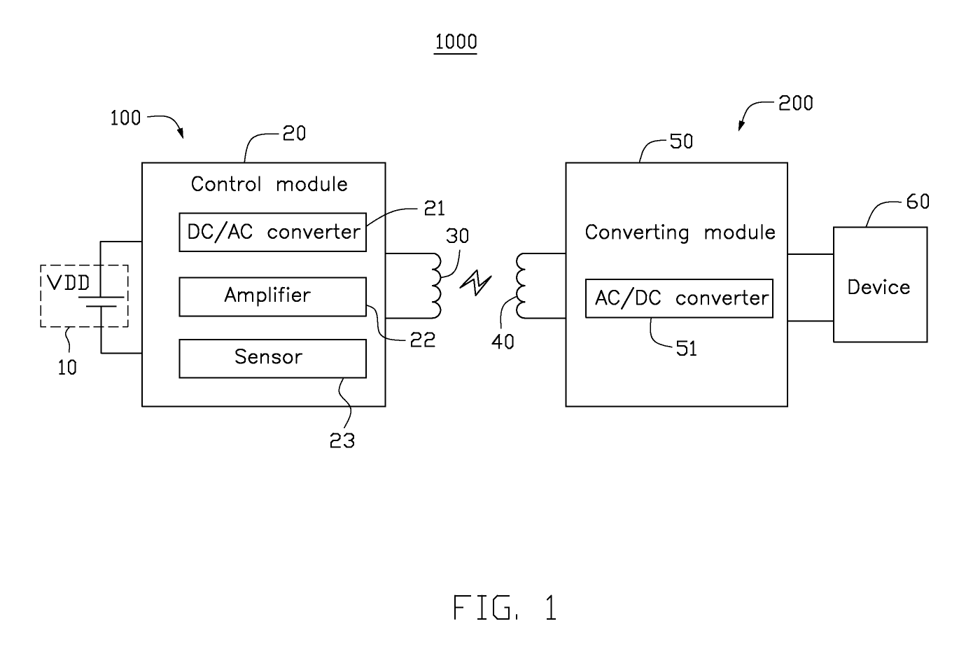

FIG. 1 illustrates an embodiment of the wireless charger system 1000. The wireless charger system 1000 can comprise a charging module 100 and at least one receiving module 200. The charging module 100 can comprise a source module 10, a control module 20, and a charging antenna 30. The receiving module 200 can comprise a receiving antenna 40, a converting module 50, and a device 60 needing to be charged. In at least one embodiment, the device 60 can be a cell phone or a notepad. In other embodiments, the device 60 can be a battery bank.

The source module 10 can comprise a direct current (DC) source VDD. The control module 20 is coupled to the DC source VDD. The charging antenna 30 is coupled to the control module 20. The DC source VDD is configured to output a first DC power. The control module 30 can comprise a DC/alternating current (AC) converter 21, an amplifier 22, and a sensor 23. The DC/AC converter 21 is configured to convert the first DC power provided by the DC source VDD to an AC power, and transmit the AC power to the charging antenna 30 for charging the device 60. The sensor 23 is configured to detect any perturbation of the current level of the AC power. The amplifier 22 is configured to increase or decrease a voltage outputted from the first DC power. When the sensor 23 detects a perturbation of the current level of the AC power, the amplifier 22 increases the voltage from the first DC power. When the sensor 23 does not detect the perturbation of the current level of the AC power, the voltage outputted from the first DC power is decreased by the amplifier 22.

The receiving antenna 40 is coupled to the charging antenna 30 and is configured to receive the AC power wirelessly. In at least one embodiment, the coupling can be achieved via a magnetic resonance. In other embodiments, the coupling can be achieved via a magnetic inductive. The converting module 50 can comprise an AC/DC converter 51. The AC/DC converter 51 is configured to convert the AC power received by the receiving antenna 40 to a second DC power for the device 60. The device 60 is coupled to the converting module 50 for receiving the second DC power to be charged.

In use, the DC/AC converter 21 converts the first DC power provided by the DC source VDD to an AC power, and transmits the AC power to the charging antenna 30. The receiving antenna 40 receives the AC power wirelessly and the AC/DC converter 51 converts the AC power to a second DC power for charging the device 60.

When the sensor 23 detects the perturbation of the current level of the AC power transmitted from the DC/AC converter 21, it is said that the first DC power provided by the DC source VDD is cannot match with a necessary voltage of the device 60. The amplifier 22 increases the voltage outputted from the first DC power, for matching the requirement of the device 60.

When the sensor 23 does not detect any perturbation of the current level of the AC power, it is said that the first DC power provided by the DC source VDD is enough to match the requirement of the device 60. The amplifier 22 decreases the voltage outputted from the first DC power for efficiency improvement of the wireless charger system 1000.

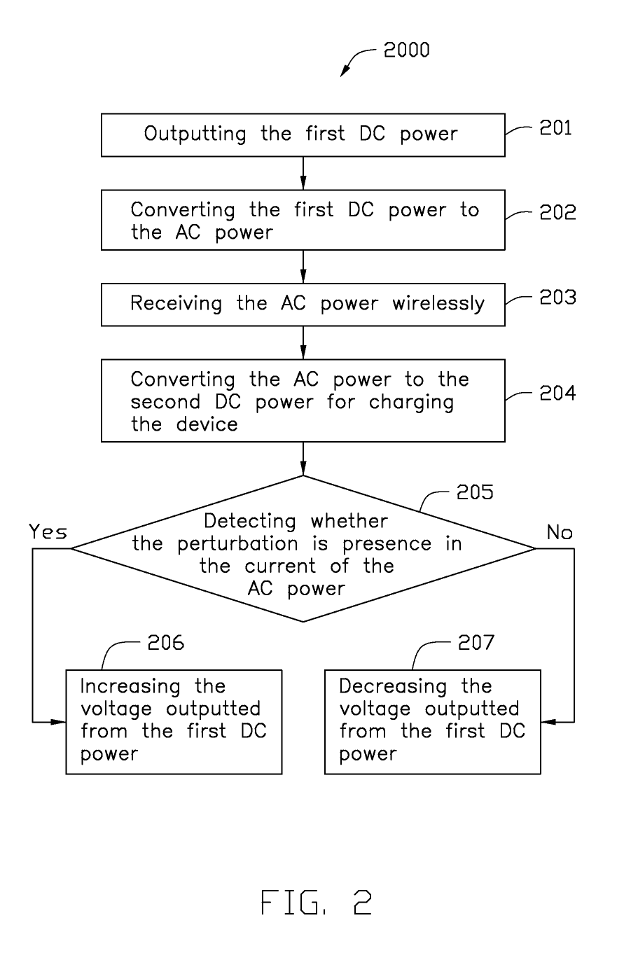

Referring to FIG. 2, a flowchart is presented in accordance with an example embodiment which is being thus illustrated. The example method 2000 is provided by way of example, as there are a variety of ways to carry out the method. The method 2000 described below can be carried out using the configurations illustrated in FIG. 1, for example, and various elements of these figures are referenced in explaining example method 2000. Each block shown in FIG. 2 represents one or more processes, methods or subroutines, carried out in the exemplary method. Additionally, the illustrated order of blocks is by example only and the order of the blocks can change according to the present disclosure. The exemplary method 2000 can begin at block 201.

At block 201, the DC source VDD outputs the first DC power.

At block 202, the DC/AC converter 21 converts the first DC power to the AC power.

At block 203, the receiving antenna 40 receives the AC power wirelessly.

At block 204, the AC/DC converter 51 converts the AC power to the second DC power for charging the device 60.

At block 205, the sensor 23 detects whether the perturbation is presence in the current of the AC power. If the perturbation is presence, procedure goes to block 206. If the perturbation is not presence, the procedure goes to block 207.

At block 206, the amplifier 22 increases the voltage outputted from the first DC power.

At block 207, the amplifier 22 decreases the voltage outputted from the first DC power.

The embodiment shown and described above is only example. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A wireless charger system comprising:
a charging module comprising:
a source module configured to output a first direct current (DC) power;
a control module coupled to the source module and configured to convert the first DC power to an alternating current (AC) power; and
a charging antenna coupled to the control module; and
at least one receiving module comprising:
a receiving antenna coupled to the charging antenna and configured to wirelessly receive the AC power from the charging antenna; and
a converting module configured to convert the AC power received by the receiving antenna to a second DC power for charging a device;
wherein the control module is also configured to detect a perturbation of the current level of the AC power, and the control module is further configured such that in event a such a perturbation is detected, the control module increases a voltage outputted from the first DC power, and further configured such that in event such a perturbation is not detected, the control module decreases the voltage outputted from the first DC power.

2. The wireless charger system of claim 1, wherein the device is a cell phone or a notepad.

3. The wireless charger system of claim 1, wherein the device is a battery bank.

4. The wireless charger system of claim 1, wherein the source module is a DC source.

5. The wireless charger system of claim 4, wherein the control module comprises a DC/AC converter, an amplifier, and a sensor, the DC/AC converter is configured to convert the first DC power provided by the DC source to the AC power, and transmitted the AC power to the charging antenna for charging the device, the sensor is configured to detect the perturbation of the current level of the AC power, and the amplifier 22 is configured to increase or decrease the voltage outputted from the first DC power.

6. The wireless charger system of claim 1, wherein coupling between the charging antenna and the receiving antenna is achieved via a magnetic resonance.

7. The wireless charger system of claim 1, wherein coupling between the charging antenna and the receiving antenna is achieved via a magnetic inductive.

8. The wireless charger system of claim 1, wherein the converting module is an AC/DC converter.

9. A wireless charger method comprising:
outputting a first DC power;
converting the first DC power to an AC power;
receiving the AC power wirelessly;
converting the AC power to a second DC power for charging a device;
detecting whether a perturbation is presence in a current of the AC power;
increasing a voltage outputted from the first DC power in response to the perturbation is presence;
decreasing the voltage outputted from the first DC power in response to the perturbation is not presence.

10. The wireless charger method of claim 9, wherein the device is a cell phone or a notepad.

11. The wireless charger method of claim 9, wherein the device is a battery bank.

12. The wireless charger method of claim 9, wherein procedure “receiving the AC power wirelessly” is achieved via a magnetic resonance.

13. The wireless charger method of claim 9, wherein procedure “receiving the AC power wirelessly” is achieved via a magnetic inductive.
